(19) United States
(12) Patent Application Publication
(10) Pub. No.: US 2006/0085569 A1
(43) Pub. Date: Apr. 20, 2006

(54) Method for minimizing the translation overhead for large I/O transfers

(75) Inventors: Patrick Allen Buckland, Austin, TX (US); Binh K. Hua, Austin, TX (US); Sivarama K. Kodukula, Round Rock, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/965,633

(22) Filed: Oct. 14, 2004

(51) Int. Cl. G06F 13/28

(52) U.S. Cl. 710/22

(57) ABSTRACT

A number of DMA addresses are resolved to system memory addresses at a time to decrease latency time. The number of addresses resolved at a time is preferably correlated to the number of DMA addresses that can be stored in a single cache line. Additionally, system memory is allocated in larger blocks that can store all of the information from the DMA addresses in a cache line. No change is required to the operating system, which can continue to operate on the page size it is set for. All changes are made in the hardware mapping programs and in the device driver software.

### BACKGROUND OF THE INVENTION

1. Technical Field

This application relates to managing addressing and memory sharing between the operating system and I/O device drivers performing direct memory access to system memory.

2. Description of Related Art

Direct Memory Access (DMA) is a hardware mechanism that allows peripheral components to transfer their I/O data directly to and from main memory without the need for the system processor to be involved in the transfer. Use of this mechanism can greatly increase throughput to and from a device, because a great deal of overhead is eliminated. A device driver will set up the DMA transfer and synchronize with the hardware, which actually performs the transfer. In this process, the device driver must provide an interface between devices that use 32-bit physical addresses and system code that uses 64-bit virtual addresses. DMA operations call an address-mapping program to map device page addresses to physical memory. Table 1 below is an exemplary address-mapping table used to convert between the device address and the system memory address.

TABLE 1

| System memory address | I/O DMA address |
|---|---|
| 9000000E 00120000 | F1000000 |
| 9000000E 00221000 | 91001000 |
| ° | ° |
| ° | ° |
| ° | ° |
| 9000000E 01010000 | F10AF000 |
| 9000000E 21002100 | F11B0000 |
| ° | ° |
| ° | ° |
| ° | ° |

Because it is necessary to call the mapping program to map the address, undesirable latencies are introduced into the DMA process, impacting I/O throughput. At times, the latency to resolve the address can be greater than the time needed to perform the actual data transfer. Therefore, in direct memory access to the system memory, new techniques for minimizing the time for this overhead operation are needed.

### SUMMARY OF THE INVENTION

In the present invention, advantage is taken of the fact that the latency time necessary to call the mapping program to resolve a single address is almost the same as the time to call the program to resolve a number of addresses. For example, when a 128-byte cache line is used to send 8-byte I/O addresses, sixteen addresses are present; the addresses for all sixteen pages can be resolved with minimal additional time over the cost of resolving one of the addresses. In order to take advantage of this fact, the inventive process requires that system memory, which is generally allocated in pages of 4 kilobytes, be allocated in blocks of n pages, with n being the number of device addresses that can be stored in a cache line. With larger blocks of memory being allocated, the driver can initiate the copying of n pages into system memory with a single call to the address-mapping program. In a cache line that can hold sixteen addresses, memory would be allocated in 64-kilobyte blocks and sixteen 4-kilobyte pages can be copied before another call to the address-mapping program. The overall wait time for accessing the address-mapping table is thus reduced, increasing I/O response time. No change is required to the pagination in the operating system, which can continue to operate on 4-kilobyte pages. All changes are made in the hardware mapping programs and in the device driver software.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts a block diagram of a data processing system in accordance with a preferred embodiment of the present invention.

FIG. 2 graphically depicts writing information to system memory by a device driver using DMA, according to an embodiment of the invention.

FIG. 3 depicts a flowchart of DMA writes from a device to system memory in accordance with an embodiment of the invention.

FIG. 4 depicts a software buffer pool and hardware buffer pool, with information being moved from one to the other according to an embodiment of the invention.

FIG. 5 depicts a flowchart of DMA writes from system memory to a device in accordance with an embodiment of the invention.

### DETAILED DESCRIPTION OF THE PREFERRED EMBODIMENT

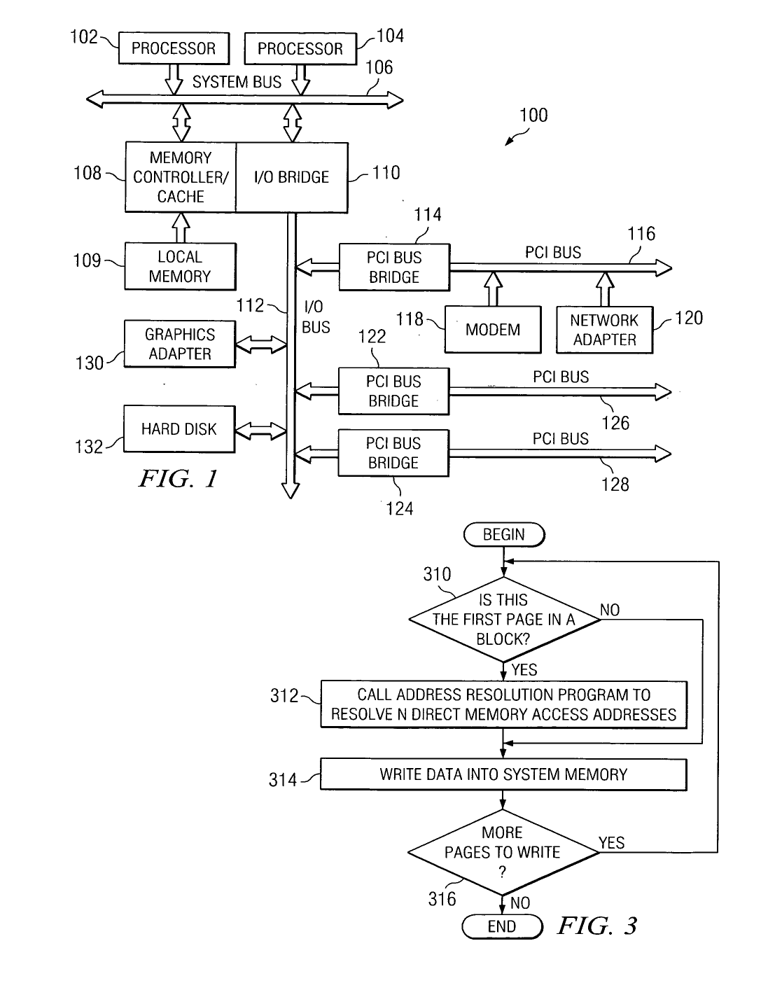

Referring now to FIG. 1, a block diagram of a data processing system is depicted in accordance with a preferred embodiment of the present invention. Data processing system 100 may be a symmetric multiprocessor (SMP) system including a plurality of processors 102 and 104 connected to system bus 106. Alternatively, a single processor system may be employed. Also connected to system bus 106 is memory controller/cache 108, which provides an interface to local memory 109. I/O bus bridge 110 is connected to system bus 106 and provides an interface to I/O bus 112. Memory controller/cache 108 and I/O bus bridge 110 may be integrated as depicted.

Peripheral component interconnect (PCI) bus bridge 114 connected to I/O bus 112 provides an interface to PCI local bus 116. A number of modems may be connected to PCI local bus 116. Typical PCI bus implementations will support four PCI expansion slots or add-in connectors.

Additional PCI bus bridges 122 and 124 provide interfaces for additional PCI local buses 126 and 128, from which additional modems or network adapters may be supported. In this manner, data processing system 100 allows connections to multiple network computers. A memory-mapped graphics adapter 130 and hard disk 132 may also be connected to I/O bus 112 as depicted, either directly or indirectly.

Those of ordinary skill in the art will appreciate that the hardware depicted in FIG. 1 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 1 may be, for example, an IBM eServer pSeries system, a product of International Business Machines Corporation in Armonk, N.Y., running the Advanced Interactive Executive (AIX) operating system or LINUX operating system.

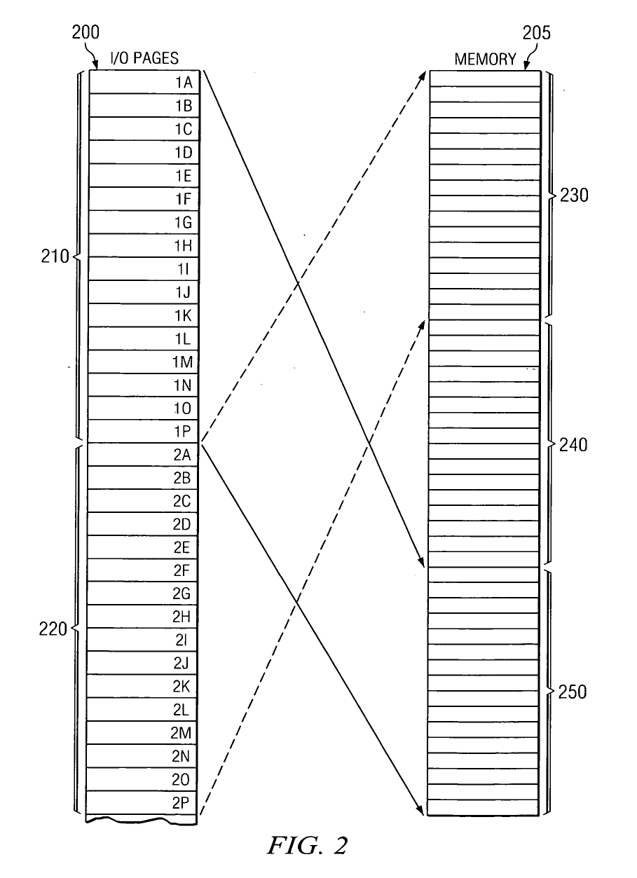

With reference to FIG. 2 an DMA transfer of several blocks of data to system memory will now be discussed in accordance with an exemplary embodiment of the invention. The information 200 that is being written from a device to system memory 205 is shown as pages 1A-2P, which are grouped into two blocks 210, 220 of 16 pages, as it is assumed in this exemplary embodiment that each cache line holds sixteen addresses. In this example, block 210 forms the first sixteen pages of data; this information is copied to sixteen contiguous pages of system memory, here block 250. The next sixteen pages of data, which forms block 220, is copied to a second block of sixteen pages of memory, here block 230. The memory in this example is always allocated in blocks of sixteen pages, although the operating system will continue to access single pages.

With reference now to FIG. 3, the method by which this data is written to system memory will now be discussed in accordance with an exemplary embodiment of the invention. The process begins with the device driver software receiving a page of information to be written to the system memory and a DMA address for the information. The driver determines if the current page is the first page in a block (step 310). If it is, the cache line containing the DMA address will also contain the DMA addresses for the succeeding n pages, where n is the number of addresses the cache line will hold. The process then calls the address-mapping routine to map system memory addresses to all n of the I/O DMA addresses present in the cache line (step 312). If the current page is not the first page in the block, then step 312 can be skipped, as this mapping has already been done for all n of the present DMA addresses. The information is then written into the allocated space in system memory (step 314). The program then checks to see if there are additional pages to be written (step 316). If there are not, the program terminates; otherwise the program returns to step 310 to process the next page. This loop continues until all information is written to memory.

Once data is written into memory, the operating system is notified, so that the requesting application can access the data. The operating system software can continue to manage the data in pages, as it has done previously. When the application is through with the data, OS releases a page at a time to be written to the device. Because OS is using pages while the hardware is allocating in larger blocks, care must be taken to ensure that all pages in a block are freed before the block is released.

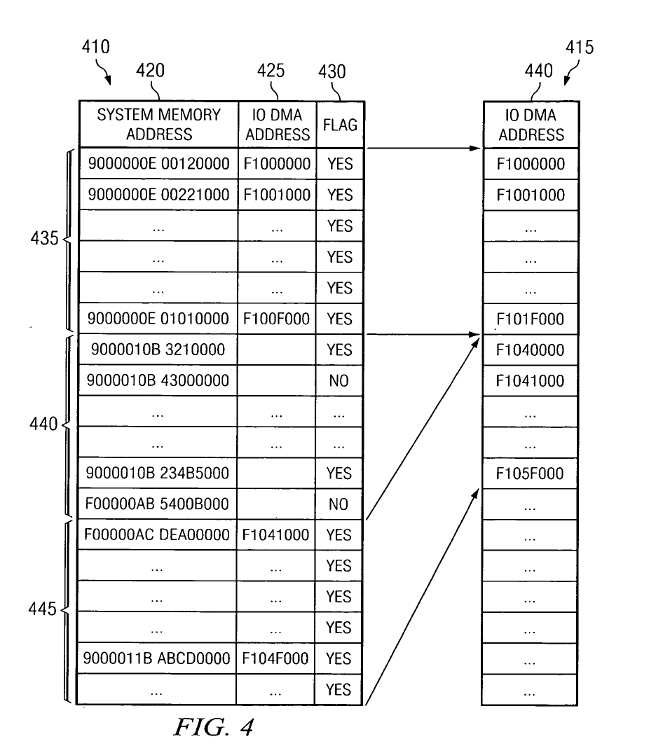

DMA writes from system memory to a device will now be discussed with reference to FIG. 4. When pages need to be written back to storage, the innovative method uses two buffer pools to manage the process, both software buffer pool 410 and hardware buffer pool 415. The device driver maintains the software buffer table; this table contains system addresses 420 of pages in the DMA blocks, each page having an associated flag 430 that indicates whether the page has been released by the system. Blocks will be moved to the hardware buffer pool only when all pages within the block have been freed. Before a block is placed in the queue for the hardware buffer, the address mapping software is called to provide the associated DMA address 425 for each page, which is then passed to the IO DMA address 440 of the output buffer pool 415. In this figure, all pages in the first block 435 have a value of ‘yes’ in the flag field 430, indicating that these pages have been freed. Therefore, the address-mapping software has been called to provide DMA addresses 425, so that these can be passed to the DMA addresses 440 of the output buffer pool 415. In the second block 440 of pages, several pages have a ‘no’ value in the flag field 430, so that this block 440 is not yet ready to be written or released. In the third block 445, once again all addresses have a ‘yes’ value in the flag field 430; this block 445 will also be written to the output buffer pool 415.

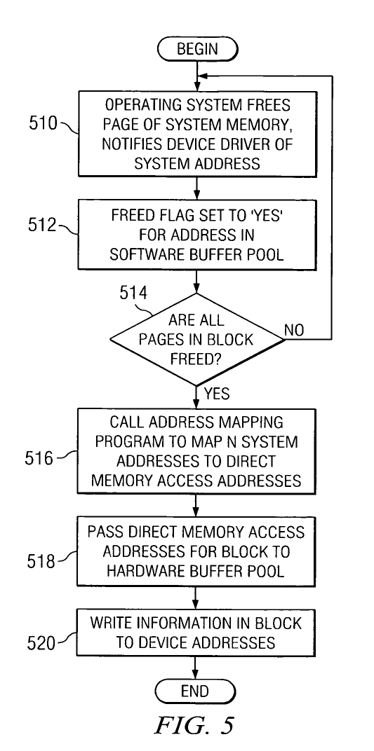

FIG. 5 depicts a flowchart of a DMA write from system memory to a device, according to an exemplary embodiment of the invention. This flow begins when the operating system frees a page of system memory and notifies the device driver of the system address of the page (step 510). The driver will set the freed flag in the software buffer pool to indicate that the page has been freed (step 512). The driver then checks to see if all pages in the block have been freed (step 514). If not, the driver continues waiting for other pages to be freed; if all pages in a block have been freed, the driver calls the address-mapping program to map the system addresses to DMA I/O addresses (step 516). These DMA addresses are then passed to the hardware buffer pool (step 518), where the hardware will manage writing the information in the block to the device addresses (step 520).

As has been shown, the innovative method does not need to call the address-mapping program as often as previously, as this program is asked to resolve the addresses for all pages in a block at one time. This means that, as illustrated above, when sixteen pages are grouped into a block, fifteen calls to the address-mapping program are avoided for every 64 KB of information managed in a direct memory access.

Of course, the inventive method of managing DMA I/O is not restricted to 64 KB transfers, but would enhance the performance of all transfers needing more than one address resolution.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A method for performing direct memory access (DMA) input/output (I/O), said method comprising the steps:
providing n DMA addresses to be resolved to n respective system memory addresses in a single call to an address mapping routine;
when said n respective system memory addresses have been resolved, storing the information from said n DMA addresses in n contiguous pages of system memory, and setting n respective indicators to a first value;
when an operating system releases one of said n pages of system memory, setting a respective one of said n indicators to a second value that is different from said first value; and
when all of said n respective indicators are set to said second value, adding said n DMA addresses to an output buffer pool.

2. The method of claim 1, further comprising the step of freeing said n contiguous pages of system memory.

3. The method of claim 2, further comprising the step of assigning said n contiguous pages of system memory to information received from a new set of n DMA addresses.

4. A method for managing system memory, said method comprising the steps:
in an operating system using said system memory, requesting and releasing system memory in pages that consist of a given number of bytes of memory;
in a device driver writing directly to said system memory and in hardware mapping of said system memory, allocating and freeing said system memory in blocks that consist of n contiguous pages of memory, where n is an integer greater than 1.

5. The method of claim 4, wherein said operating system requests and releases system memory in pages that consist of 4 kilobytes of memory.

6. The method of claim 4, further comprising using a address-mapping program to translate device addresses to physical addresses in system memory.

7. The method of claim 4, wherein a respective flag is kept for each page, wherein said flag has a first value if said operating system has freed a respective page of system memory and a second value if the operating system has not freed a respective page of system memory.

8. The method of claim 7, wherein a given block is released for re-allocation only after a respective flag for each of said n pages in said given block has said first value.

9. A computer system comprising:
an operating system running on a processor;
a system memory accessed by said processor; and
a device connected to perform direct memory access (DMA) on said system memory;
wherein said operating system requests and releases system memory in pages that consist of a fixed number of bytes of memory;
wherein a device driver writing to said system memory allocates and frees said system memory in blocks that consist of n contiguous pages of memory, where n is an integer greater than 1.

10. The computer system of claim 9, wherein said operating system requests and releases system memory in pages that consist of 4 kilobytes of memory.

11. The computer system of claim 9, wherein said device driver uses an address-mapping program to translate device addresses to corresponding physical addresses in system memory,

12. The computer system of claim 9, wherein a respective flag is maintained for each page, wherein each flag has a first value if said operating system has freed a respective page of system memory and a second value if said operating system has not freed a respective page of system memory.

13. The computer system of claim 12, wherein a block is released for re-allocation only after a respective flag for each of said n pages in said block has said first value.
